(19) United States
(12) Patent Application Publication
(10) Pub. No.: US 2016/0176640 A1
(43) Pub. Date: Jun. 23, 2016

(54) MOSAIC LINER FOR CHUTE/HOPPER LINING

(71) Applicant: TEGA INDUSTRIES LIMITED, Kolkata, West Bengal (IN)

(72) Inventors: Sarjo Kumar ROY, Kolkata, West Bengal (IN); Madan Mohan MOHANKA, Kolkata, West Bengal (IN)

(21) Appl. No.: 14/907,042

(22) PCT Filed: Sep. 9, 2013
(86) PCT No.: PCT/IN2013/000544

§ 371 Date: Jan. 22, 2016

(30) Foreign Application Priority Data
Jul. 26, 2013 (IN) 893/KOL/2013

(51) Int. Cl. B65G 11/16

(52) U.S. Cl. CPC B65G 11/166

(57) ABSTRACT

A mosaic liner unit (A) for chute/hopper lining comprises of a body having a front face (10) and a rear face (11). Each of the front face (10) and the rear face (11) are made of an elastomeric material (2). Within the elastomeric material is embedded a plurality of high hardness steel units (3). The front face (10) is adapted to take the impact load of material falling on the chute/hopper and the rear face (11) is fixed to chute/hopper wall (12).

### FIELD OF THE INVENTION

The present invention relates in general to chute/hopper liners in material handling of bulk solids which are lumpy and abrasive, and in particular to mosaic liners for chute/hopper lining which provide damping action against the high impact forces that result due to falling of such material on the chute walls and resistance to abrasion wear. The damping action is achieved by the presence of rubber in steel matrix. A plurality of such liners form a flat array to cover the surface of the chute/hopper wall or any surface desired to be protected from such wear.

### BACKGROUND AND PRIOR ART

In the following discussion, only chutes are mentioned for brevity although the present invention is equally applicable to hoppers and other similar applications as known to persons skilled in the art.

In material handling operations, conveyor belts are used for conveying or transporting material from one station to another station. When material has to be transferred between conveyors at different heights or between conveyors moving in different directions, chutes are used. Chutes are flat plates, having relatively smooth transferring surface, arranged at different angles to transfer or guide materials along the chute under force of gravity. Since the ore particles are dense and hard and discharged from the conveyor belt to the chute at considerable velocity, they may scratch and scrape away on the surface of the chute resulting in severe chute wear, if left unprotected. This wear may finally tear the plate, forming holes in chute faces, leading to leakage of material. Hence chutes have to be replaced, which activity stops the production for a long time. This downtime while the conveyer system is not in operation, results in loss of productivity. Such losses need to be kept at a minimum.

To avoid this, liners are used. Liners are small rectangular blocks, used as sacrificing cover for protection of chutes. These are mechanically fastened to the chute wall.

Mainly two types of wear can be observed in material handling equipment, particularly in the chutes.

Impact wear: When large size particles or large lumps being handled in the material handling system strike the surface of the chute with a high force, the wear taking place is impact wear.

Abrasion wear: As all particles are not spherical or smooth, they have sharp edges which erode the liner surface. This is termed as abrasion wear. Sliding abrasion is a function of pressure, friction coefficient and sliding velocity. Abrasion wear is high in soft materials.

Chute plates, if left unprotected, wear out with time due to continuous flow of material in them. This wear may finally tear the plate, and puncture holes in chute faces, leading to leakage and wastage of material. In such condition, entire chutes have to be replaced which halts the production for a long time.

To avoid this, liners are used. Liners are small rectangular plates, used as cover for chute mother plates. These are mechanically fastened to an inner surface of the chute body.

### BENEFITS OF CHUTE LINERS

1) Facilitates repair and replacement of sliding surface

2) Means of correcting the performance of an inadequate chute

3) Avoids abrasion wear of chute

4) Reduces impact wear, noise, dust and material degradation

5) Promotes smooth flow

6) Avoids build-up of material

7) Prevents chemical reaction or corrosion of both chute and product

An ideal chute liner should resist both impact and abrasion wear, enhance flow of material and reduce degradation and fines generation.

Conventionally, steel liners have been used in chutes of bulk material handling systems which handle rocky, lumpy and granular heavy material in the mining, steel and other industries.

Steel liners are generally a good solution for such applications, but suffer from some drawbacks. When steel liners are installed in a high impact zone of a chute i.e. the area where moving materials have the initial impact on the chute wall, many times micro crack formation occurs on their surface. This is a result of high impact fatigue wear. So there has been a long felt need to develop liners for chute walls, which can withstand high impact load in addition to abrasion wear and is capable of absorbing impact energy.

The mosaic liners for chute/hopper lining according to the present invention meet the aforesaid long felt need of the prior art and other needs associated therewith.

### OBJECTS OF THE INVENTION

The primary object of the invention is to provide a mosaic liner for chute/hopper walls that is ideally suitable both for high impact loads and abrasion wear and is capable of absorbing impact energy.

Another object of the invention is to provide a liner which has reduced material weight, making it cost effective.

Yet another object of the invention is to provide a liner which is more user-friendly, making its installation easier and less time-consuming.

Another object of the invention is to eliminate need for frequent chute/liner replacements.

A further object of the invention is to achieve reduction in stoppage of operation of the material handling system due to chute liner replacement.

A still further object of the invention is to provide a liner which helps in absorption of sound, thereby reducing noise pollution in material handling.

How the foregoing objects are achieved will be clear from the following description. In this context it is clarified that the description provided is non-limiting and by way of explanation.

### SUMMARY OF THE INVENTION

Accordingly, the present invention provides a mosaic liner unit for chute/hopper lining comprises of a body having a front face and a rear face, each of said front face and said rear face being made of an elastomeric material within which is embedded a plurality of high hardness steel units, the front face being adapted to take the impact load of material falling on the chute/hopper and the rear face being fixed to chute/hopper wall.

In accordance with preferred embodiments of the mosaic liner of the present invention:

the elastomeric material is synthetic rubber and the hard steel units are of varying shape depending upon the type of application intended to be served by the liner unit;

the liner unit is fixed to the chute/hopper wall with the help of bolt and nut arrangement through bolt holes located throughout the front face and rear face of the liner unit at different locations on the liner body, each bolt hole being provided with a cylindrical portion surrounding it, for firm fixation with the chute/hopper wall;

the liner unit is fixed to the chute/hopper wall with the help of studs welded to the mother plate of the chute/hopper wall and thereafter passed through bolt holes and fastened with nut and washer, the bolt holes being located throughout the front face and rear face of the liner unit at different locations on the liner body and the bolt holes are provided with a cylindrical portion surrounding it, for firm fixation with the chute/hopper wall;

the bolts are located either only on the elastomeric portion or only on the hard steel portion or on both;

the hard steel units float within the elastomeric material;

in a mild steel plate is provided as backing for the liner unit and the hard steel units are welded or otherwise fixed with the mild steel plate;

the hard steel units are welded or otherwise fixed to the mild steel plate at the base and the elastomeric material portion is chemically bonded with these steel components;

for fixing the liner to the chute wall, a stud is welded to the chute wall and the stud passes through the rubber hole and the hole in mild steel plate and is fastened with nylock nut that rests on mild steel plate.

The present invention also provides an array comprising of a plurality of liner units as described hereinbefore placed side-by side, each of which are attached to the chute/hopper wall.

### BRIEF DESCRIPTION OF THE ACCOMPANYING DRAWINGS

The nature and scope of the present invention will be better understood from the accompanying drawings, which are by way of illustration of the preferred embodiments and not by way of any sort of limitation. In the accompanying drawings:

FIG. 1 is the front view of the mosaic liner unit according to the present invention.

FIG. 2 is the back view of the mosaic liner unit of FIG. 1.

FIG. 3 is the isometric view of mosaic liner unit.

FIG. 4 is a side view of the mosaic liner units according to the invention.

FIG. 5 shows an isometric view of a second preferred embodiment of the mosaic liner unit having irregular high hardness steel units.

FIG. 6 is the isometric view of an array comprising of several liner units.

FIG. 7 is a side view showing the fixing arrangement of the liners with the chute wall.

### DETAILED DESCRIPTION OF THE INVENTION

Having described the main features of the invention above, a more detailed and non-limiting description of some preferred embodiments will be given in the following paragraphs, with reference to the accompanying drawings.

In all the figures like reference numerals represent like features.

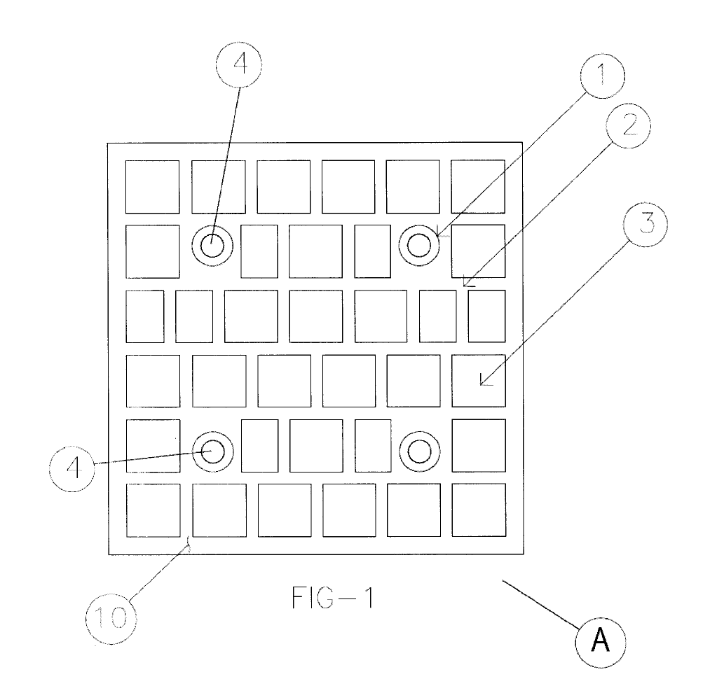

The Mosaic liner unit (A) according to the present invention is best shown in FIGS. 1, 2 and 3 in its first preferred embodiment.

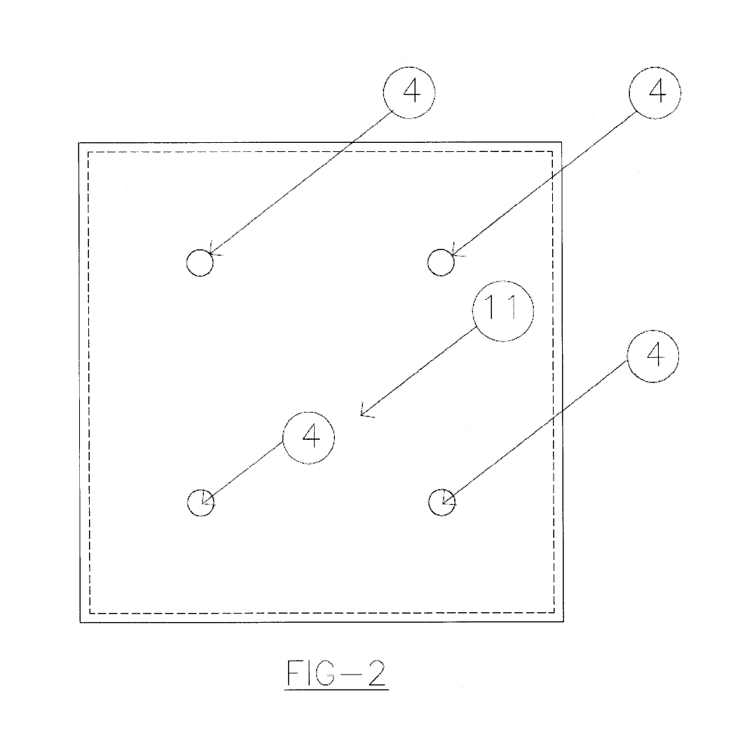

The body of the liner unit is made from elastomeric material, most preferably synthetic rubber (2). A plurality of high hardness steel units (3) is embedded in it. The liner unit (A) has two faces. The front face (10), shown in FIG. 1, takes the impact load of the material falling on the chute and the back face (11), shown in FIG. 2, is fixed on to the chute wall (12), the latter being shown in FIG. 7. The prime aim of the present invention is to protect this chute wall (12).

FIG. 1 is a view of the front face (10) of the liner. It comprises the synthetic rubber portion (2) within which is embedded the hard steel units (3). The hard steel units (3) are all shown as rectangular in this figure. However, the shapes may be different as explained later, depending upon the type of application. Each liner unit has a plurality of bolt holes (4) which are located throughout the body of the liner unit and may have various different locations on the rubber body of the unit. A cylindrical portion (1) is provided surrounding each bolt hole (4). This portion ensures firm fixing of the liner on the chute wall (12) {shown in FIG. 7}.

Although not shown in any of the figures, it is within the scope of the present invention that the bolts holes (4) are located either only on the elastomeric portion (2) or only on the hard steel portion (3) or on both (2,3).

FIG. 2 is a view of the rear face (11). It also shows the bolt holes (4).

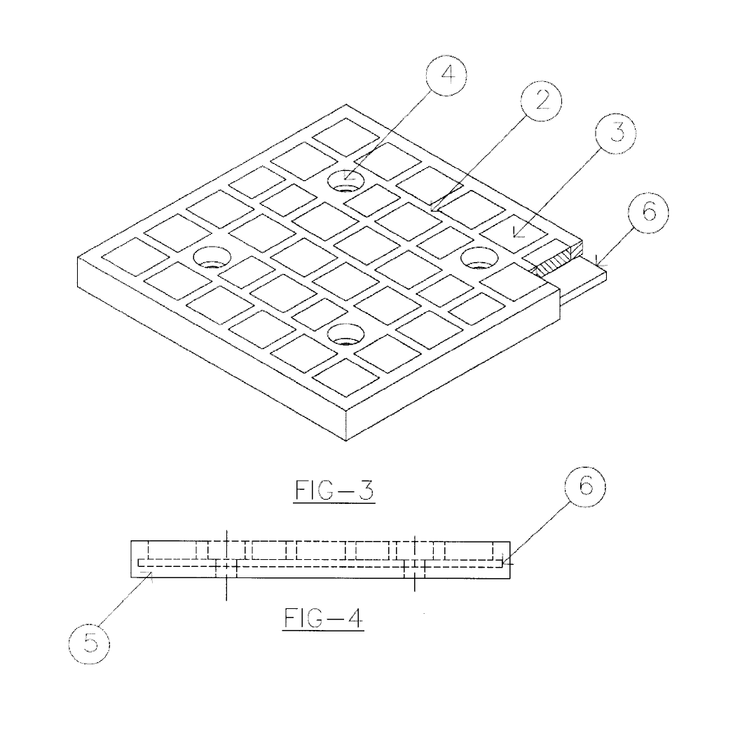

FIG. 3 is an isometric view of the mosaic liner unit front face (10) and rear face (11) whereof are shown in FIGS. 1 and 2 respectively. The configuration of the different components would be clear from this figure. In addition this figure also shows that a mild steel plate (6) is provided as backing for the liner unit described above. The hard steel units (3) are welded or fixed with the mild steel plate (6) and this arrangement forms an integral part of the liner unit (A). The hard steel units (3) are welded or otherwise fixed to the mild steel plate (6) at the base and rubber (2) is bonded chemically with both these steel components of the liner unit (A).

Alternatively, the embedded steel units (3) can also float in the elastomeric material of the liner body.

FIG. 4 is a side view of the mosaic liner shown in FIG. 3. It shows the mild steel plate (6) and in particular clearly illustrates that this plate has a thickness (5).

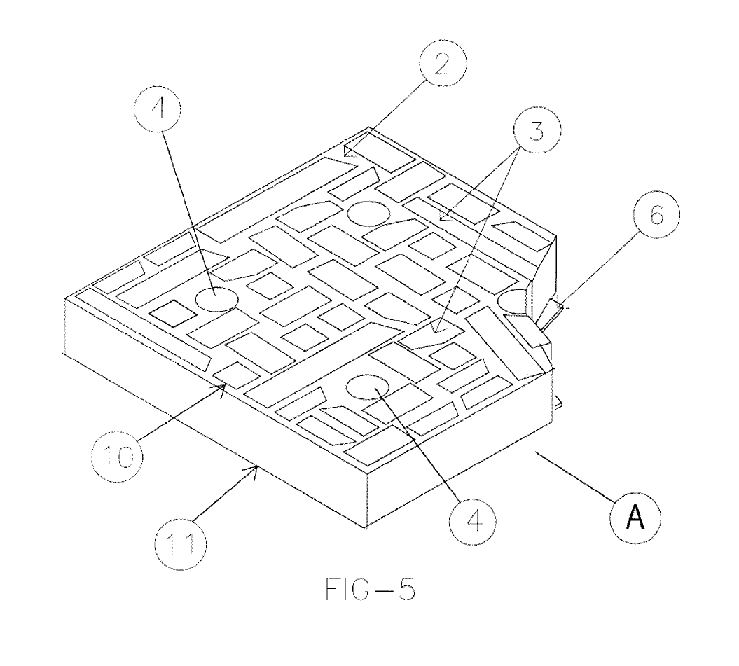

The hard steel units (3) are either rectangular in shape as shown in FIG. 1 or are of different shapes and sizes (i.e., square, rectangular or any regular or irregular shape) as shown in FIG. 5, depending upon the type of application the liner is intended to serve. Rubber (2) surrounds the steel units (3) and acts as a cushion to absorb the impact forces.

In an embodiment, with reference to FIG. 4, for attaching the liner with the chute wall (12), the bolt head (not shown) rests on the mild steel plate (6) with the leg passing through the hole(not shown) in mild steel plate (6) and through the hole (4 best shown in FIGS. 1,2 and 3) in rubber.

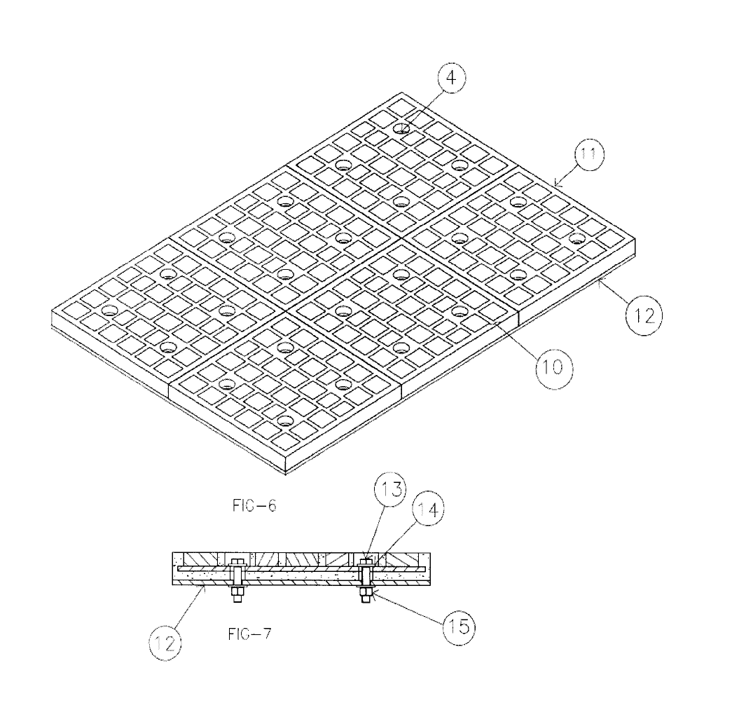

Alternate fixing can be done with the stud in which case a stud (not shown) is welded to the chute wall (12 best shown in FIG. 6) and the stud passes through the rubber hole (4 best shown in FIGS. 1,2 and 3) and through the hole (not shown) in mild steel plate (6 best shown in FIGS. 3 and 4) and is fastened with nylock nut (not shown) that rests on mild steel plate (6).

FIG. 5 is the perspective view of another preferred embodiment of the mosaic liner unit. It explains that hard steel units (3) can be of different shapes and sizes.

As shown in FIG. 6, a plurality of such liner units placed side-by side forms an array (B) of liners. The chute wall (12) is protected by several such liners fixed on to it.

FIG. 7 shows the details of fixing of the liner units on to the chute wall (12). They are fixed to the chute wall (12) with the help of bolt and nut arrangement (13, 14, 15) through bolt holes (4).

Alternatively, as explained before with reference to FIG. 4, the fixing can be with the help of stud instead of bolt. In case of stud fixing the stud is welded to the mother plate of the chute wall (12 best shown in FIG. 6). The stud is then passed through the bolt hole (4) of the liner and is fastened with the help of nut and washer.

As mentioned, steel units (3) are of all shapes, size and thickness and may be both regular and irregular. These steel units serve as first impact zone and takes all impact load exerted by the material falling on the chutes. On the other hand the rubber (2) beneath and around the embedded steel serves as a cushion and absorbs the impact energy imparted by the material on the embedded steel. The rubber matrix (2) helps in absorption of sound, thereby reducing noise pollution in material handling plants. Rubber being less in weight compared to steel reduces the overall weight of the liner unit without compromising the wear life performance.

This novel and inventive composite structure of the chute liner of the present invention exploits the advantages of both rubber and steel, making the liner ideally suitable both for high impact loads and abrasion wear. The invented chute liner therefore offers a cost-effective solution to the problems of the prior art mentioned earlier.

### The advantages of the present invention are:

1. Reduced impact wear

2. Reduced noise

3. Possibility of installation in high impact zones

4. Reduced material weight

5. Reduced cost

6. Elimination of frequent chute replacement

7. Reduction in stoppage of operation.

The present invention has been described with reference to some drawings and preferred embodiments purely for the sake of understanding and not by way of any limitation and the present invention includes all legitimate developments within the scope of what has been described herein before and claimed in the appended claims.

1. A mosaic liner unit for chute/hopper lining comprises of a body having a front face and a rear face, each of said front face and said rear face being made of an elastomeric material within which is embedded a plurality of high hardness steel units, the front face being adapted to take the impact load of material falling on the chute/hopper and the rear face being fixed to chute/hopper wall.

2. The mosaic liner unit as claimed in claim 1 wherein the elastomeric material is synthetic rubber and the hard steel units are of varying shape depending upon the type of application intended to be served by the liner unit.

3. The mosaic liner unit as claimed in claim 1 wherein the liner unit is fixed to the chute/hopper wall with the help of bolt and nut arrangement through bolt holes located throughout the front face and rear face of the liner unit at different locations on the liner body, each bolt hole being provided with a cylindrical portion surrounding it, for firm fixation with the chute/hopper wall.

4. The mosaic liner unit as claimed in claim 1 wherein the liner unit is fixed to the chute/hopper wall with the help of studs welded to the mother plate of the chute/hopper wall and thereafter passed through bolt holes and fastened with nut and washer, the bolt holes being located throughout the front face and rear face of the liner unit at different locations on the liner body and the bolt holes are provided with a cylindrical portion surrounding it, for firm fixation with the chute/hopper wall.

5. The mosaic liner unit as claimed in claim 1 wherein the bolts are located either only on the elastomeric portion or only on the hard steel portion or on both.

6. The mosaic liner unit according to claim 1 wherein the hard steel units float within the elastomeric material.

7. The mosaic liner unit according to claim 1 wherein a mild steel plate is provided as backing for the liner unit and the hard steel units are welded or otherwise fixed with the mild steel plate.

8. The mosaic liner unit as claimed in claim 7 wherein the hard steel units are welded or otherwise fixed to the mild steel plate at the base and the elastomeric material portion is chemically bonded with these steel components.

9. The mosaic liner as claimed in claim 7 wherein for fixing the liner to the chute wall, stud is welded to the chute wall and the stud passes through the rubber hole and the steel hole and fastened with nylock nut that rests on the mild steel plate.

10. An array comprising of a plurality of liner units as claimed in claim 1 placed side-by side, each of which are attached to the chute/hopper wall.
